(19) United States
(12) Patent Application Publication
(10) Pub. No.: US 2026/0023237 A1
(43) Pub. Date: Jan. 22, 2026

(54) COMPACT OPTICAL MOUNT OPTIMIZED FOR STABILITY IN PHYSICALLY AND THERMALLY DYNAMIC APPLICATIONS

(71) Applicant: Dimer Instruments, Inc., Santa Barbara, CA (US)

(72) Inventors: Shiladitya Sen, Durgapur (IN); Andrew Amaral, Santa Margarita, CA (US); Michael Larkin, Santa Barbara, CA (US)

(21) Appl. No.: 18/777,221

(22) Filed: Jul. 18, 2024

(51) Int. Cl. G02B 7/00

(52) U.S. Cl. CPC G02B 7/004; G02B 7/008

(57) ABSTRACT

A compact optical mount optimized for stability in physically and thermally dynamic applications is disclosed. An example optical mount apparatus includes a body. The body includes a bore for an optical element, a first opening for a first fastener, and a first flexure arm. Tightening of the first fastener of the optical mount apparatus against the first flexure arm causes a second flexure arm to pivot around a flexure element and increase a size of the bore.

### BACKGROUND

Optical systems designed to direct, focus, and detect light illumination are integral to many scientific and industrial instruments. Specific examples of this type of instrumentation include dynamic light scattering, static light scattering, and fluorescence devices that are used to characterize molecules in solutions. The overall performance of these optical systems is often constrained by the stability, precision, thermal management, weight, and usability of the optical mounting and alignment mechanisms. These challenges are well known to those skilled in the art of designing optical systems.

Regarding the alignment of optical systems, many solutions for improving the precision and stability of alignment have been proposed. These solutions include using high-precision positioning mechanisms, which often incorporate rails and roller bearings; or kinematic assemblies, which frequently utilize high-pitch screws with spherical alignment balls on flats working against flexures or springs. These approaches aim to achieve fine, precise adjustments and maintain alignment under varying conditions. Even so, current alignment mechanisms often underperform the specifications required for advanced optical systems.

Regarding the mounting of optical elements, many different approaches have been proposed. The most basic mounting designs involve using adhesives to secure optical elements to alignment mechanisms. Adhesives have known limitations in thermal cycling applications and often present challenges during assembly. Another common practice is circumferentially tightening a split ring around an optical element. This approach offers simplicity, but can suffer from causing local deformation of the optical element and/or performance issues that are related to variability in the tightening of the screw during assembly. More sophisticated techniques include the use of radial spring elements or jacket sleeves to achieve a stable connection. However, these techniques require the addition of extra components which increase complexity, cost, and, most importantly, thermal and physical mass.

Individually and combined, all of these known mounting and alignment approaches often prove substandard. Performance issues can manifest by causing: 1) variation in performance due to the optical assembly process, 2) system failure from shock and vibration during transportation, 3) sub-optimal application performance due to limitations in alignment precision, and/or 4) overall thermal or physical mass effecting the system's dynamic response.

Therefore, there is a need for an improved optical alignment and mounting mechanism that offers superior performance by reducing thermal and physical mass while enhancing resilience to transport and manufacturing variations. This mechanism would address the limitations of current methods, providing greater stability, precision, and usability in demanding optical applications.

### SUMMARY

Disclosed herein is a steerable mount for optical systems that maximizes both static and dynamic mechanical and thermal performance at a minimum manufacturing and assembly cost.

Objectives of the present invention may be achieved by fabricating a monolithic optical flexure from a suitable material, such as Titanium grade 5 (Ti6Al4V) or 17-4 stainless steel. The material is chosen such that the mass and thermal properties are optimized while also ensuring the flexure's spring force is sufficient to overcome all shock and vibration requirements. Further, the material should be selected such that during operation over the entire alignment range, the flexure does not experience inelastic deformation. The monolithic design itself reduces the overall number of components, thereby reducing mass, thermal mass, increasing the surface area available for heat exchange, and lowering assembly cost.

Embodiments of the present invention differ from other mounting arrangements in how the optical element mounts into the device. While known optical mounts use a split clamp that is slightly oversized and then tightened on the optical element, embodiments disclosed herein use a split clamp that is slightly undersized and then forced open through the use of a screw. When the screw is removed, the pre-loading of the split clamp uniformly and reliably holds the optical element with a force sufficient to withstand the application's demands (including shock and vibration), but not so much as to damage the optical element. This approach has a number of advantages. First, the screw itself may be fully removed from the optical mount assembly once mounting is complete. Removal of the screw reduces the total assembly's mass by the weight of the screw. Such weight reduction is particularly important in dynamic applications, but also both lowers the thermal mass and increases the exposed surface area of the assembly thereby improving the rate at which the optical mount assembly will thermally equilibrate (i.e., the thermal transfer coefficient).

An additional advantage of releasing the split clamp screw to secure the optical element is that the clamping force applied to the optical element by the optical mount is controlled by precise machining tolerances. In known optical mounts, the clamping force on the optical element is controlled instead by the amount of torque applied by the assembler during the assembly process. However, when applying clamping through releasing a clamping screw (e.g., rather than tightening), there may be potential for variability in the torque applied to the clamping screw by the assembler as they force open the clamp. Also, there is often a great variability between the torque applied to a screw and the corresponding longitudinal force applied by the screw. During normal operation, the clamp flexure does not exceed its elastic deformation limit. However, if the clamp is “over opened,” deformation could be possible. For example, if the screw is tightened such that the clastic deformation limit of the optical mount is exceeded, plastic deformation of a portion of the optical mount may occur. Such over-opening may be prevented by limiting the amount of displacement of the clamping screw. For example, the depth of the threaded hole that the clamp screw uses may be controlled. However, it is difficult and expensive to precisely control the depth of a threaded hole. Examples disclosed herein provide a simple way to prevent over-flexing by adding a stop to prevent the clamp screw from being over-tightened (e.g., going too deep into the optical mount). In certain embodiments, prevention of over-tightening is accomplished in an inexpensive way by adding a threaded hole and a bolt as a stop. Similar to the split clamp screw, after assembly is complete this stop-bolt may be removed, thereby reducing mass, reducing thermal mass, and increasing the surface area of the optical mount available for heat exchange.

Optical alignment and mounting systems are generally mounted with bolts or springs to an optical chassis. In certain embodiments in this disclosure, the mounting kinematics can be integrated into the monolithic mount by removing material during the fabrication process to create three pads on the mounting surface. These three pads may define three of six degrees of freedom of the mount. To define the remaining three of the six degrees of freedom of the mount, additional material is removed, thus forming two points along one edge and one point along another edge. Like the other innovations disclosed here, the removal of the additional material, without adding other alignment facilities, reduces mass, reduces thermal mass, and increases surface area available for heat exchange.

Known flex mounts typically use an external spring or a metal flexure as a spring force to hold the mount to a desired angular position. Between the two options, using the flexure itself is preferred as a spring force because it reduces complexity and size compared to use of an external spring. Thus, use of the flexure itself allows for a smaller optical assembly with reduced physical and thermal mass. When a flexure is used to apply the spring force, the flex mount must be flexed to a starting angle to achieve the minimum required spring force. It is advantageous if the mount includes features that allow the assembler to know when the mount is flexed to the nominally correct starting angle and pre-loading force. The pre-loading force must be adequate to withstand the application of external forces that are applied through either regular use or unexpected shocks or vibrations. In certain embodiments in this disclosure, pre-loading the flexure is accomplished with a groove that can capture a round pin with a known groove angle/depth. With such a groove, if a pin of the correct dimensions is barely able to slide between the groove and the flat of the opposing face then the initial spring force, and thus angle, are nominally correct. Like the other innovations disclosed here, the removal of the groove material, without adding other pre-alignment facilities, reduces mass, reduces thermal mass, and increases surface area available for heat exchange. In certain embodiments, the two plates attached to the flexure can be fabricated at an angle, such that when the flexure is pre-loaded, the plates become parallel.

In many optical systems it is required to align focal points of optics to within fractions of the beam waist. In a light scattering application, for example, this may mean both the laser launch and collector optics have beam waists of approximately 40 μm and be overlapping to within approximately 2 μm in three dimensions. During a typical optical alignment process, the beam Poynting vector and the location of the minimum beam waist are measured, sometimes simultaneously and sometimes singly, for the laser launch, collector, and/or additional beams. At the beginning of the optical alignment process, the beams will in general not overlap well, and the axial location of the minimum beam waists will be different. After measurement, it is known how much the axial location of the minimum beam waists should be adjusted (e.g., forwards or backwards), and time is saved in the manufacturing process if the beams can be quickly and simply adjusted by that distance.

In certain embodiments in this disclosure, axial adjustment is accomplished through the addition of a screw (e.g., a pushing screw, an adjustment screw) with a head/flat feature that pushes against the back of an optic assembly (e.g. an optical element, a light source or a light collector). By calculating the desired z-offset (e.g., axial offset) of the minimum beam waist and knowing the thread pitch of the adjustment screw, it can be known exactly how many turns and/or fractions of a turn to adjust the pushing screw to position the optic optimally in the axial direction. If the desired adjustment is such that the pushing screw is screwing into the flex mount block, then the pushing screw itself will directly push the optical element such that the push force is sufficient to move the optic to the correct axial position. If the desired adjustment is such that the adjustment screw is being unscrewed from the flex mount block, then the optical element which is being lightly held may be pushed down by hand or by other mechanical means until it impacts the adjustment screw. After optical alignment is completed and the optic is secured in position, the adjustment screw can be completely removed from the assembly, reducing the mass, reducing the thermal mass, and increasing the surface area available for heat exchange.

The Poynting vector of the optic may be adjusted latterly using two rotational axes of adjustment. For each rotational axis of adjustment, a flex mount (e.g., the optical mount disclosed herein) typically has a body section, a ball ended adjustment screw, and a hard flat that the ball on the adjustment screw pushes against. The thermal expansion of the material of the body of the optical mount may be different than the thermal expansion of an adjustment screw and both may be different from that of the ball and hard flat. For example, some optical mounts arc fabricated using Titanium grade 5 or 17-4 stainless steel. To prevent the ball-screw from binding in the mount, the ball-screw is typically made of a different material from the body, e.g. with a Ti grade 5 body the screw may be phosphor bronze. To prevent the distal end of the screw from indenting the mount, the contact point is typically made from yet another material, e.g. sapphire or silicon-carbide. As the temperature of the optical assembly is changed, the different thermal expansion coefficients of the three disparate materials of the body, the ball, and the hard flat will in general result in a change in the angle at which the optical element is held. In certain embodiments in this disclosure, these three materials are purposefully chosen such that one is greater than and one is less than that of the optical mount body, and the dimensions and thickness of the mount gap and hard flat thickness are purposely chosen to result in zero or near zero relative thermal expansion of the screw/flat combo as compared to the body of the flex mount.

A consequence of minimizing the size and mass of the alignment mount, as disclosed herein, is that the mass of the “mounted” optical systems can now be relevant to the devices overall stability under extreme loads. For example, the shock and vibrations experienced in a drop from 1 m can be in the range 10's of g-forces. ISO standards for shock and vibration can range from 10's to 1000's of g-forces depending on the equipment's specific operational environment and intended use. Many adjustable optical mounts have locking mechanisms that allow the position of the mount to be secured after alignment such that the alignment will not change when the unit is exposed to shock or vibration. Such locking mechanisms add complexity, cost, mass, and thermal mass to a system.

Known optical systems would be improved if locking mechanisms were not required to maintain optical alignment. A locking mechanism may not be required if the spring force holding the flexure in position is strong enough to overcome the momentary forces associated with the applied shock and vibration. This approach cannot be generally applied because as the mass of the optical assembly increases, the torques created from shock forces increase, and these forces cannot be compensated beyond the indentation yield strength of either the ball or hard flat without causing permanent misalignment and/or other system problems.

In certain embodiments in this disclosure, the alignment mount is made for a specific mounted mass. With this value defined, the torque on the flex mount in both the positive and negative directions can be calculated as a function of the dimensions and materials of the mount, and the relevant g-forces. Because designs nominally have different values of mass*distance on either side of the flex hinge, each design has a nominal sensitivity to shock or vibration. In this disclosure, the monolithic flexure is specifically designed to minimize (e.g., reduce to zero) the mass*distance on each side of the flexure by either removing mass from one side of the hinge, and/or by adding mass to the other side of the hinge. Removing mass has the benefits described previously. Adding mass to improve high g-force stability must be weighed against the benefits of better mechanical system dynamics within the specific application. In certain embodiments the optical mount design is engineered to withstand predetermined external force when holding an optical assembly of known mass by adjusting the masses on each side of the hinge, the hinge geometry, and the pre-load force. It should be noted that the force that holds the optic into the mount must also be sufficient to prevent the optic from moving axially from a shock or vibration, and this clamping force must also be considered in this calculation.

Aspects of the subject matter described herein may be useful alone or in combination with one or more other aspect described herein. Without limiting the foregoing description, in a first aspect of the present disclosure, an optical mount apparatus includes a body including a bore for an optical element; a first opening for a first fastener; and a first flexure arm, wherein tightening of the first fastener against the first flexure arm causes a second flexure arm to pivot around a flexure element and increase a size of the bore.

In accordance with a second aspect of the present disclosure, which may be used in combination with the first aspect, the body of the optical mount further includes a second opening for a second fastener, wherein when the second fastener is installed in the second opening, the second fastener limits tightening of the first fastener.

In accordance with a third aspect of the present disclosure, which may be used in combination with any other aspect disclosed herein, the installed second fastener prevents the second flexure arm from exceeding its elastic deformation limit.

In accordance with a fourth aspect of the present disclosure, which may be used in combination with any other aspect disclosed herein, the body of the optical mount further includes a third opening for a third fastener, wherein when the third fastener is installed in the third opening, the third fastener limits translation of the optical element through the bore.

In accordance with a fifth aspect of the present disclosure, which may be used in combination with any other aspect disclosed herein, translation of the third fastener in the third opening causes the optical element to translate through the bore.

In accordance with a sixth aspect of the present disclosure, which may be used in combination with any other aspect disclosed herein, the size of the bore is smaller than the size of a portion of the optical element mounted in the bore.

In accordance with a seventh aspect of the present disclosure, which may be used in combination with any other aspect disclosed herein, the body of the optical mount is fabricated from a single monolithic block of material.

In accordance with an eighth aspect of the present disclosure, which may be used in combination with any other aspect disclosed herein, an optical mount apparatus comprises a body comprising: a bore for an optical element on a top plate; a first alignment flexure between a top plate of the body and a middle plate of the body, the top plate including the bore; and a second alignment flexure between the middle plate and a lower plate of the body, wherein the first alignment flexure and the second alignment flexure flexing adjusts an the angle of the top plate; and a first ball-ended alignment screw; and a first hard flat on a bottom portion of the top plate; wherein tightening the first ball-ended alignment screw against the first hard flat causes flexion in the first alignment flexure.

In accordance with a ninth aspect of the present disclosure, which may be used in combination with any other aspect disclosed herein, one of a material of the first ball-ended alignment screw and a material of the first hard flat has a thermal expansion coefficient greater than a thermal expansion coefficient of a material of the body of the optical mount apparatus and the other one of the material of the first ball-ended alignment screw and the material of the first hard flat has a thermal expansion coefficient less than the thermal expansion coefficient of the material of the body of the optical mount apparatus.

In accordance with a tenth aspect of the present disclosure, which may be used in combination with any other aspect disclosed herein, dimensions and a material of the first ball-ended alignment screw, dimensions of a ball of the first ball-ended alignment screw, dimensions and a material of the first hard flat, dimensions of a gap between the top plate and the middle plate, and a material of the body are selected to minimize a change in angle of the first alignment flexure due to temperature change.

In accordance with an eleventh aspect of the present disclosure, which may be used in combination with any other aspect disclosed herein, an optical mount apparatus further includes a second-ball-ended alignment screw; and a second hard flat on a bottom portion of the middle plate, wherein tightening of the second ball-ended alignment screw causes flexion in the second alignment flexure.

In accordance with a twelfth aspect of the present disclosure, which may be used in combination with any other aspect disclosed herein, one of a material of the second ball-ended alignment screw and a material of the second hard flat has a thermal expansion coefficient greater than a thermal expansion coefficient of a material of the body of the optical mount apparatus and the other one of the material of the second ball-ended alignment screw and the material of the second hard flat has a thermal expansion coefficient less than the thermal expansion coefficient of the material of the body of the optical mount apparatus.

In accordance with a thirteenth aspect of the present disclosure, which may be used in combination with any other aspect disclosed herein, dimensions and a material of the second ball-ended alignment screw, dimensions of a ball of the second ball-ended alignment screw, dimensions and a material of the second hard flat, dimensions of a gap between the middle plate and the bottom plate, and a material of the body are selected to minimize a change in angle of the first second flexure due to temperature change.

In accordance with a fourteenth aspect of the present disclosure, which may be used in combination with any other aspect disclosed herein, an optical mount apparatus further includes an optical element of known mass secured into the bore; and a mass of the body is designed to minimize one or more of a difference between a first sum of mass times distance on a first side of the first alignment flexure and a second sum of mass time distance on a second side of the alignment flexure, and a difference between a third sum of mass times distance on a first side of the second alignment flexure and a fourth sum of mass times distance on a fourth side of the second alignment flexure.

In accordance with a fifteenth aspect of the present disclosure, which may be used in combination with any other aspect disclosed herein, one or more lightening holes are added to the top plate to minimize the difference between the first sum of mass and the second sum of mass.

In accordance with a sixteenth aspect of the present disclosure, which may be used in combination with any other aspect disclosed herein, one or more lightening holes are added to the middle plate to minimize the difference between the third sum of mass and the fourth sum of mass.

In accordance with a seventeenth aspect of the present disclosure, which may be used in combination with any other aspect disclosed herein, a method of designing an optical mount apparatus includes determining a first thermal expansion of a screw portion of the optical mount apparatus; determining a second thermal expansion of a hinge portion of the optical mount apparatus; determining a differential expansion based on a difference between the first thermal expansion and the second thermal expansion; and selecting materials for one or more components of the optical mount apparatus and selecting dimensions of one or more components of the optical mount apparatus to minimize the differential expansion.

In accordance with an eighteenth aspect of the present disclosure, which may be used in combination with any other aspect disclosed herein, the first thermal expansion is based one or more of a length of a screw, a length of a ball, a length of a hard-flat, a coefficient of thermal expansion of the screw, a coefficient of thermal expansion of the ball, and a coefficient of thermal expansion of the hard-flat.

In accordance with a nineteenth aspect of the present disclosure, which may be used in combination with any other aspect disclosed herein, the second thermal expansion is based on one or more of a length of a gap, a length of a pocket, a coefficient of thermal expansion of a hinge, and a coefficient of thermal expansion of a base plate.

In accordance with an twentieth aspect of the present disclosure, which may be used in combination with any other aspect disclosed herein, a method for mounting an optical element in an optical mount includes tightening a first fastener in a body of the optical mount to increase a size of a bore in the body of the optical mount; inserting the optical element in the bore; and removing the first fastener from the body of the optical mount.

In accordance with a twenty-first aspect of the present disclosure, which may be used in combination with any other aspect disclosed herein, tightening the first fastener in the body of the optical mount until translation of the first fastener is limited by a second fastener in the body of the optical mount.

In accordance with a twenty-second aspect of the present disclosure, which may be used in combination with any other aspect disclosed herein, a method for mounting an optical element further includes removing the second fastener from the body of the optical mount after the removing of the first fastener.

In accordance with a twenty-third aspect of the present disclosure, which may be used in combination with any other aspect disclosed herein, inserting the optical element into the bore until the optical element is limited in translation by a third fastener in the body of the optical mount.

In accordance with a twenty-fourth aspect of the present disclosure, which may be used in combination with any other aspect disclosed herein, a method for mounting an optical element further includes translating the optical element by translating the third fastener through the body of the optical mount.

In accordance with a twenty-fifth aspect of the present disclosure, which may be used in combination with any other aspect disclosed herein, a method for mounting an optical element further includes tightening one or more alignment screws to adjust an angle of a top plate of the body of the optical mount.

In accordance with a twenty-sixth aspect of the present disclosure, any of the structure and functionality illustrated and described in connection with FIGS. 1 to 9 may be used in combination with any of the structure and functionality illustrated and described in connection with any of the other of FIGS. 1 to 9 and with any one or more of the preceding aspects.

In light of the present disclosure and the above aspects, it is therefore an advantage of the present disclosure to provide an improved optical alignment and mounting mechanism that offers superior performance over known mounts.

It is another advantage of the present disclosure to reduce thermal and physical mass of an optical mount.

It is a further advantage of the present disclosure to enhance resilience to transport and manufacturing variations of an optical mount.

It is an additional advantage of the present disclose to maximize static and dynamic mechanical and thermal performance for an optical mount.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. Also, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

FIG. 1A is a diagram showing an example optical system using a plurality of optical mounts, according to an example embodiment of the present disclosure.

FIG. 1B is a diagram of example optical systems that may be mounted into one of the optical mounts of the example optical system of FIG. 1A.

FIG. 2 is a diagram of the mounting and alignment features of a first known optical mount.

FIG. 3 is a diagram of the mounting and alignment features of a second known optical mount.

FIG. 4A is a diagram of a front perspective view of a compact optical mount with adjustment screws in the mount, according to an example embodiment of the present disclosure.

FIG. 4B is a diagram of a front perspective view of the compact optical mount of FIG. 4A with adjustment screws removed from the mount, according to an example embodiment of the present disclosure.

FIG. 5A is a diagram of a front view of the compact optical mount of FIG. 4A with an optical assembly installed and with adjustment screws in the mount, according to an example embodiment of the present disclosure.

FIG. 5B is a diagram of a front view of the compact optical mount of FIG. 5A with an optical assembly installed and with the adjustment screws removed from the mount, according to an example embodiment of the present disclosure.

FIG. 6A is a diagram of a side view of the compact optical mount of FIG. 4A with adjustment screws in the mount, according to an example embodiment of the present disclosure.

FIG. 6B is a diagram of a side view of the compact optical mount of FIG. 6A with adjustment screws removed from the mount, according to an example embodiment of the present disclosure.

FIG. 7 is a schematic diagram for the calculation of balancing thermal expansion of the hinge of the optical mount of FIGS. 4A-6B with the screw and flat, according to an example embodiment of the present disclosure.

FIG. 8 is a flow diagram illustrating an example procedure for minimizing thermal expansion effects for an optical mount, according to an example embodiment of the present disclosure.

FIG. 9 is a flow diagram illustrating an example procedure for mounting an optical element in an optical mount, according to an example embodiment of the present disclosure.

### DETAILED DESCRIPTION

The present disclosure relates in general to a method, system, and apparatus for a compact optical mount optimized for stability in physically and thermally dynamic applications. As disclosed herein, the optical mount comprises a monolithic optical mount featuring a pre-loaded flexure for holding an optical assembly.

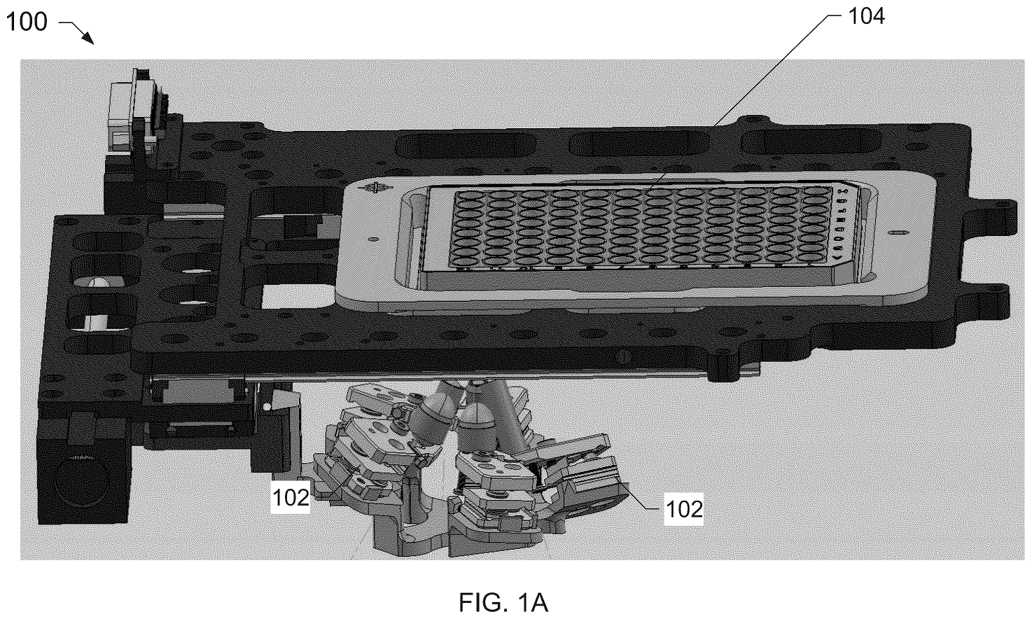

FIG. 1A shows an example optical system 100 using a plurality of optical mounts 102. In this example, the optical system 100 is a multi-well plate based static light scattering, dynamic light scattering, and fluorescent instrument for measuring stability in pharmaceutical formulation processes. In this optical system 100, illumination and collection optics must be focused through the transparent bottom of a standard well plate 104, at a known fixed distance above the well bottom. The locations of focus for both the illumination and collection optics must be positioned relative to each other, and to the well, withing the gaussian diameter of the beams, or much less than 40 um.

The optical system 100 is scanned so the focal points can interrogate each of the wells in the standard well plate 104. To accomplish this, it is advantageous to scan the optical system rather than the plate 104. By scanning the smaller optics, rather than the larger plate 104, several advantages can be achieved. First, the overall footprint of the instrument is reduced. Second, the pharmaceutical formulations being interrogated do not experience agitation, which could result in unaccounted for aggregation.

Since the rate at which one can move between all the wells in the well plate, and the rate at which the entire assembly can change temperature are important performance metrics, it is important to keep the total mass of the optical system 100 to a minimum. Thus, it is critical to reduce both the physical and thermal mass of the five optical mounts 102 shown in this example.

FIG. 1B shows example optical systems 106, 108, 110, 112 that may be mounted into an optical mount such as one of the optical mounts 102 of FIG. 1A. The example optical systems 106, 108, 110, 112 generally consist of a focusing optical element connected to a fiber, which is in turn connected to a light source or light detector. These systems may be standardized for a particular application, and therefore their mass can be known for adapting the optical mount's dynamic properties.

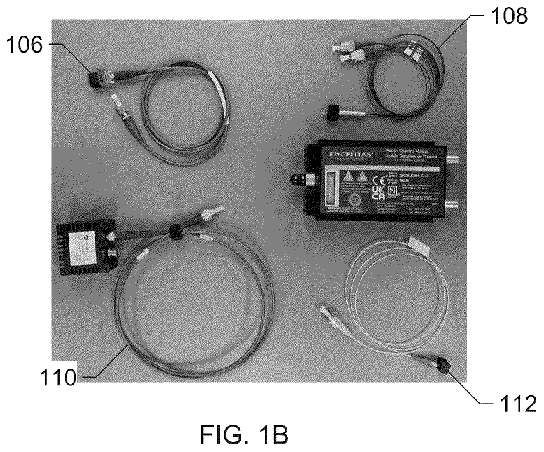

FIG. 2 illustrates a prior art optical mount 200. An optical element can be mounted and secured to a bore 202 of the prior art optical mount 200 using a built-in set screw, adhesive wells, or by permanent bonding to the mount. As described above, such mounting techniques have known limitations.

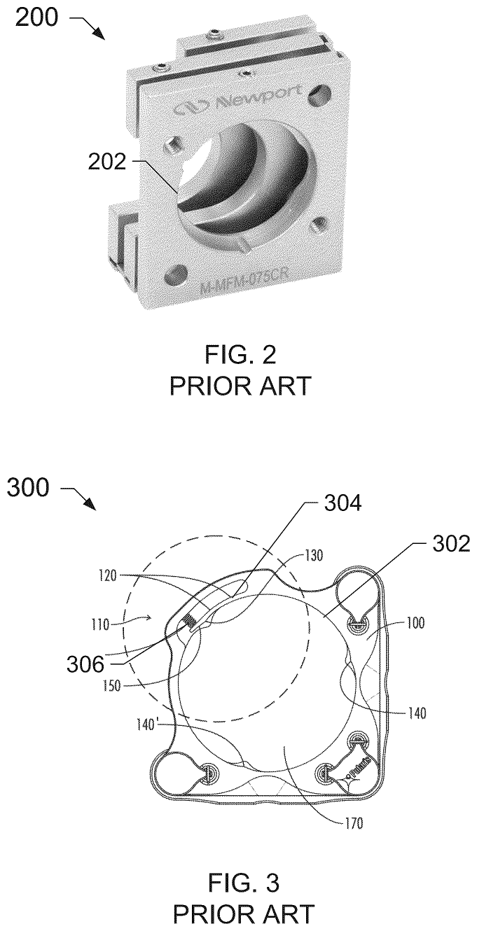

FIG. 3 illustrates a second prior art optical mount 300 having a bore 302 for accommodating an optical element. The second prior art optical mount 300 uses a radial spring clamping arm 304 to secure the optical element when a locking screw 306 is tightened. Such a mounting technique may achieve a stable connection, but the addition of extra components increases complexity, cost, and most importantly thermal and physical mass. It is also possible to overtighten such a design, resulting in permanent inelastic deformation of the flex clamp.

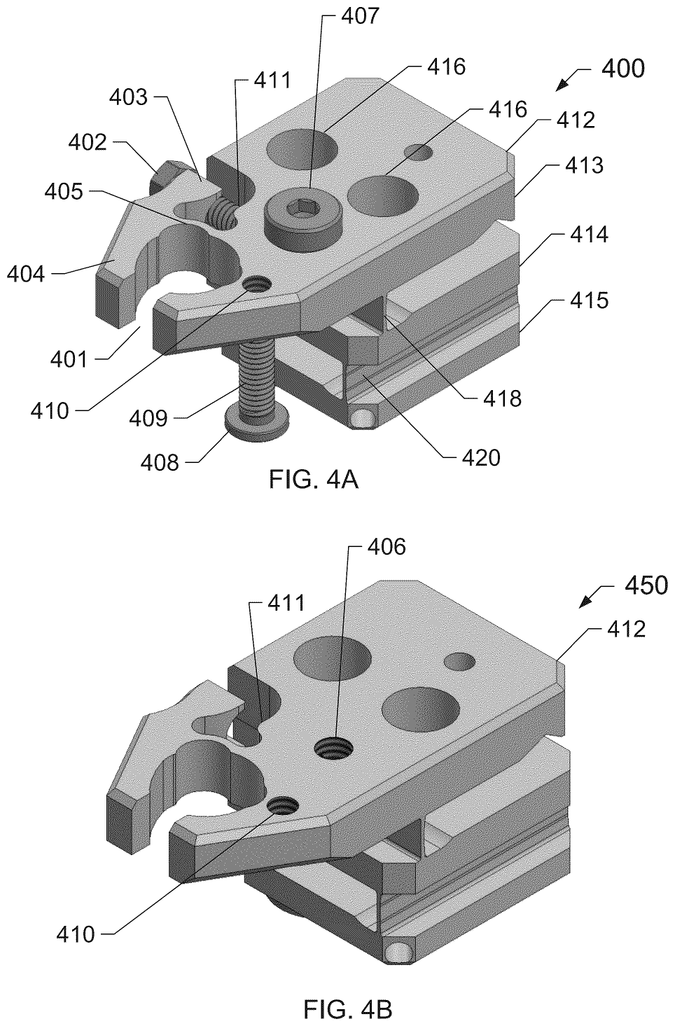

FIG. 4A shows an optical mounting system 400 according to an example embodiment of the present disclosure. The example optical mounting system 400 of FIG. 4A is optimized for stability in dynamic mechanical and thermal applications. The example optical mounting system 400 may be used to connect an optical element to a chassis. For example, an optical element (e.g., the optical element 106, 108, 110, 112 of FIG. 1B) may be mounted to the optical mounting system 400 which may be connected to an optical system (e.g., the optical system 100 of FIG. 1A). In other examples, the optical mounting system 400 may be connected directly to an optical table, or may be connected to any other mounting chassis for use of the optical element.

The optical mounting system 400 includes an optical mount 412 (e.g., an optical mount apparatus). The example optical mount 412 makes up a body of the optical mounting system 400. The example optical mount 412 is machined from a single monolithic block of material using wire EDM or other similarly capable technique known to those in the art. In other examples, the optical mount 412 may be machined from two or more blocks of material and the two or more blocks of material may be joined to form the optical mount 412.

The example optical mount 412 includes a cutout 401 (e.g., a bore, an opening, a hole). An optical element which the optical mount 412 connects to the chassis is axially aligned to the cutout 401. The example optical mount 412 further includes a first tapped hole 411 for mounting a first screw 402 (e.g., a clamping screw, a fastener, a first fastener) to the optical mount 412. The example first tapped hole 411 (e.g., screw hole, opening, threaded opening, hole, threaded hole) may be tapped at a pitch corresponding to a pitch of threads of the first screw 402. In other examples, the first screw 402 may be a fastener type other than a screw having a body and a head and the first tapped hole 411 may be tapped or untapped based on the fastener type.

The example optical mount 412 further includes a first flexure arm 403. The example first flexure arm 403 includes an opening sized to accommodate a body of the first screw 402. A head of the first screw 402, however, interferes with (e.g., comes in contact with) an outer surface of the first flexure arm 403 when the first screw 402 is tightened into the first tapped hole 411. The lateral translation of the first screw 402 into the outer surface of the first flexure arm 403 causes flexion of the first flexure arm 403. For example, the first flexure arm 403 may flex around an axis orthogonal to a top surface of the optical mount 412.

Flexure of the first flexure arm 403 further causes flexion (e.g., deformation, clastic deformation) of a second flexure arm 404. Flexion of the second flexure arm 404 may cause an increase in size (e.g., diameter) of the cutout 401. For example, the example second flexure arm 404 may pivot around a flexure element 405. The example flexure element 405 may be a portion of the optical mount 412 which allows for controlled flexion of the second flexure arm 404. For example, the flexure element 405 of the example optical mount 412 includes a locally decreased cross-sectional area having a decreased load capacity relative to other areas of the optical mount 412. Thus, when the second flexure arm 404 flexes in response to the flexure of the first flexure arm 403, the second flexure arm 404 pivots around the flexure element 405 causing the increase of the size of the cutout 401.

In examples disclosed herein, a size (e.g., a diameter) of the cutout 401 is slightly smaller (e.g., 1% smaller, 5% smaller, 10% smaller, etc.) than a size (e.g., a diameter) of an optical element to be mounted to the optical mount 412. As such, when the first screw 402 is tightened against the first flexure arm 403, the second flexure arm 404 pivots around the flexure element 405 and increases the size of the cutout 401 allowing insertion of the optical element into the cutout 401. The dimensions of the flexure element 405 may be designed to provide the desired clamping force when the second flexure arm 404 is offset to accommodate the diameter of the optical element. The calculation of the geometry of flexure element 405 may depend on several variables. These variable may include one or more of the physical characteristics of the optic element to be held (e.g., how much force it can withstand), the contacting surface area between the optical mount 412 and the optic element, the coefficient of friction between the material of the optic mount 412 and the optic element, and/or the amount of force the optic element must be able to withstand without moving (e.g., direct force, shock, vibration). The details of this calculation are known to those skilled in the art.

Care must be taken to keep the second flexure arm 404 from flexing such that the flexure element 405 exceeds its elastic deformation limit. This calculation is known to those skilled in the art. To prevent the second flexure arm 404 from inadvertently exceeding the elastic deformation limit of the flexure element 405 (e.g., due to an error in the assembly process such as the first screw 402 being inadvertently tightened too much causing the cutout 401 to increase to a size larger than can be accommodated by the flexure element 405), the example optical mount 412 includes a second tapped hole 406 and a second screw 407 (e.g., a positioning screw, a fastener, a second fastener). The example second tapped hole 406 (e.g., screw hole, opening, threaded opening, hole, threaded hole) may be tapped at a pitch corresponding to a pitch of threads of the second screw 407.

The example second tapped hole 406 is positioned such that when the second screw 407 is inserted into the second tapped hole 406, a body of the second screw 407 creates a hard stop for the first screw 402. This approach is advantageous because, using standard machining tolerances, it is straight forward to precisely locate the second tapped hole 406 to stop the first screw 402 from plastically deforming the flexure element 405. In other examples, the second screw 407 may be a fastener type other than a screw having a body and a head and the second tapped hole 406 may be tapped or untapped based on the fastener type (e.g., a pin).

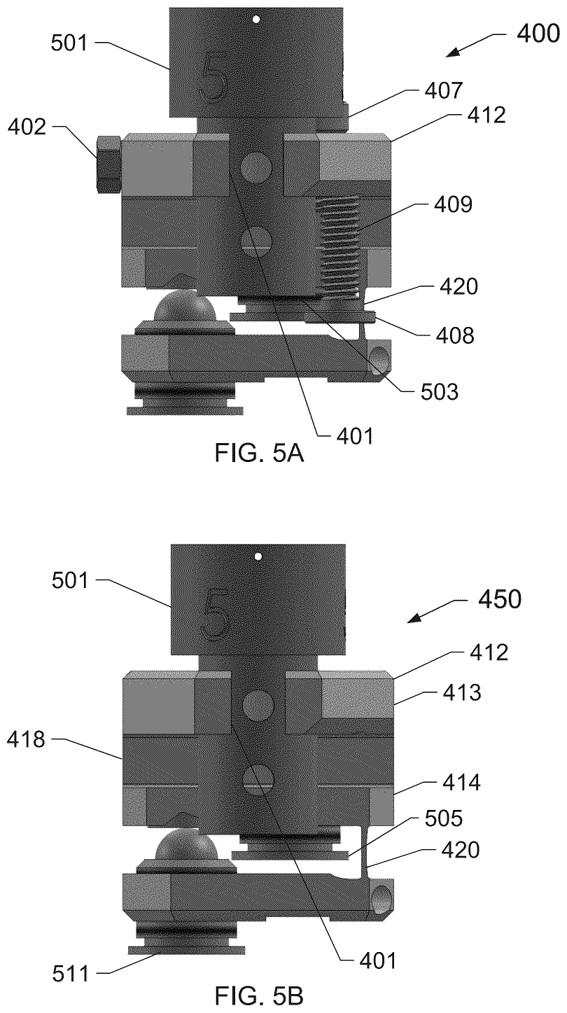

The example optical mount 412 further includes a third tapped hole 410 and a third screw 409 (e.g., an alignment screw, a fastener, a third fastener). The example third tapped hole 410 (e.g., screw hole, opening, threaded opening, hole, threaded hole) may be tapped at a pitch corresponding to a pitch of threads of the third screw 409. The example third screw 409 has a screw head 408 and may be inserted into the third tapped hole 410 to assist with axial alignment of an optical element in the cutout 401. In other examples, the third screw 409 may be a fastener type other than a screw having a body and a head and the third tapped hole 410 may be tapped or untapped based on the fastener type. Axial adjustment of an optical element using the third screw 409 is discussed below in conjunction with FIG. 5A.

The optical mount 412 further includes a top plate 413, a middle plate 414, and a lower plate 415. The optical mount 412 further includes a first alignment flexure 418 connecting the top plate 413 and the middle plate 414 and a second alignment flexure 420 connecting the middle plate and the lower plate 415. The example top plate 413 includes the cutout 401, the first tapped hole 411, the second tapped hole 406, the third tapped hole 410, the first flexure arm 403, the second flexure arm 404 and the flexure element 405. The example middle plate 414 and the example lower plate 415 may be aligned (e.g., via flexure of the first alignment flexure 418 and/or the second alignment flexure 420) for operation and alignment of the optical mount 412.

The example top plate 413 further includes one or more lightening holes 416 designed to decrease a mass of the optical mount 412. The one or more lightening holes 416 may also balance the mass on each side of flexure 418 such that the optical mount will stay in alignment when subjected to shock and vibration forces. Such mass balancing may minimize and/or reduce a force on the optical mount apparatus 400 when the optical mount apparatus 400 is subject to one or more of shock or vibration.

For example, a sum of mass multiplied by distance may be calculated for the optical mount apparatus 400 on one side of one of the alignment flexures (e.g., the first alignment flexure 418 or the second alignment flexure 420). Additionally, a sum of mass multiplied by distance may be calculated for the optical mount apparatus 400 on the other side of the alignment flexure (e.g., the first alignment flexure 418 or the second alignment flexure 420). The sums of mass calculated may depend on a known mass of an optical element that is secured in the cutout 401 of the optical mount 412. The mass of the optical mount 412 may then be adjusted based on the calculated sums of mass. For example, it may be desirable to minimize a difference between the sums of mass on either side of one or both of the alignment flexures in order to minimize and/or reduce a force on the optical mount apparatus when the optical mount apparatus 400 is subject to one or more of shock or vibration. Thus, the mass of the optical mount 412 may be adjusted (e.g., by adding one or more lightening holes 416) in order to minimize the difference(s).

FIG. 4B shows an optical mounting system 450 according to an example embodiment of the present disclosure. The example optical mounting system 450 includes the optical mounting system 400 of FIG. 4A having the first screw 402, the second screw 407, and the third screw 409 removed. For example, after an optical element is mounted in the cutout 401 of the optical mounting system 400, the first screw 402, the second screw 407, and the third screw 409 may be removed as discussed in further detail below in conjunction with FIG. 5B.

FIG. 5A shows the example optical mounting system 400 of FIG. 4A having an optical element 501 nominally in place. If the optical element 501 is loosely secured by the first screw 402, the optical system can be adjusted axially in the cutout 401 until a bottom edge 503 of the optical element 501 makes contact with the screw head 408 of the third screw 409 threaded in the third tapped hole 410. The third tapped hole 410 is located such that, when installed, the screw head 408 of the third screw 409 slightly interferes with the bottom edge 503 of the optical element 501. Thus, the optical element 501 will stop (e.g., will be limited in axial movement) when pressed against the screw head 408. However, the screw head 408 does not interfere with any optical or electrical elements. If necessary, a special feature may be included on the optical element 501 to engage with the screw head 408.

In this orientation, the screw head 408 can also push the optical element 501 axially through the cutout 401 when the third screw 409 is engaged. Since the pitch of the third screw 409 is known, the optical element 501 can be precisely adjusted in the axial direction by calculating how many turns and fractions of turns are needed to make the appropriate adjustment.

FIG. 5B shows the example optical mounting system 450 of FIG. 4B having the optical element 501 in place. Once the optical element 501 is properly adjusted in the axial direction, the first screw 402, the second screw 407, and the third screw 409 can all be completely removed from the optical mount 412. The removal of these screws both lowers the mass of the optical mounting system 450 and increases the exposed surface area of the optical mount 412. For example, the surface area is increased because the surfaces of the first tapped hole 411, the second tapped hole 406 and the third tapped hole 410 are now exposed to ambient.

The example optical mount 412 further includes a first alignment screw 505, a first alignment hard-flat 507 (not shown), a first ball 509 (not shown), and a second alignment screw 511. The example first alignment flexure 418 is flexible such that the first alignment flexure 418 may be flexed to adjust the angle of the top plate 413 relative to the middle plate 414 using the first alignment screw 505. Additionally, the example second alignment flexure 420 is flexible such that the second alignment flexure 420 may be flexed to adjust the angle of the middle plate 414 relative to the lower plate 415 using the second alignment screw 511. For example, the first alignment screw 505 may be a ball-ended screw terminating in the first ball 509. The example first alignment hard-flat 507 may be recessed within a lower surface of the top plate 413. The example first alignment screw 505 can be adjusted such that the first ball 509 pushes against the first alignment hard-flat 507 and causes flexure of the first alignment flexure 418. As such, the angle of the top plate 413 relative to the middle plate 414 can be adjusted.

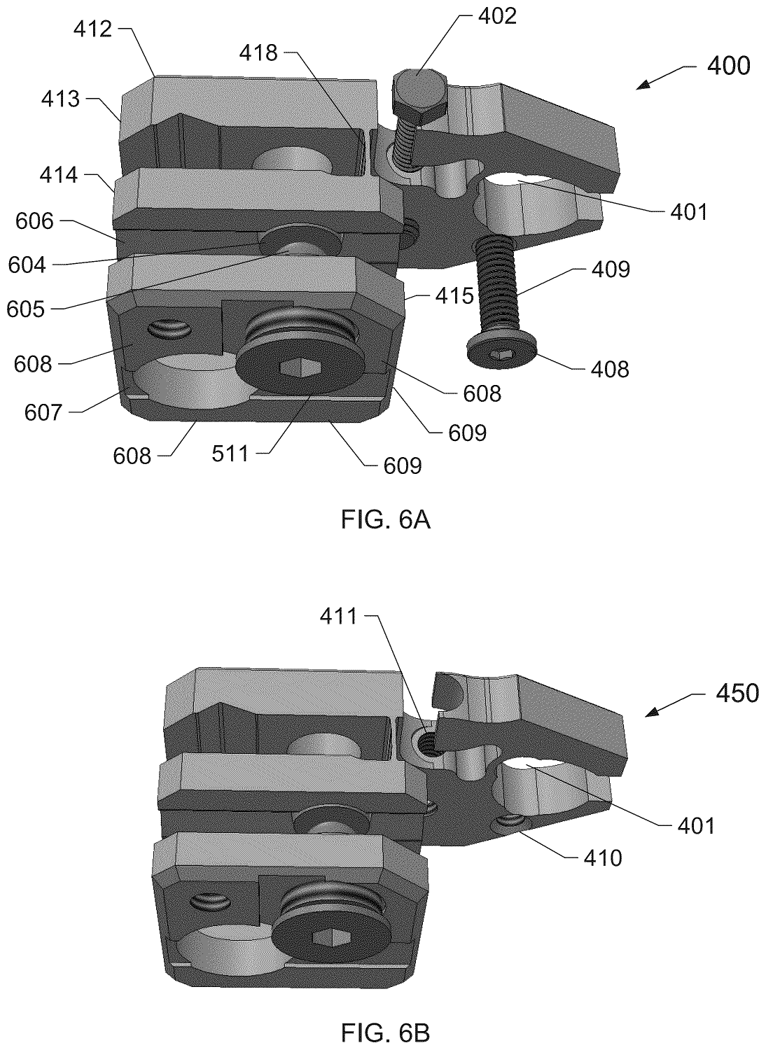

FIG. 6A shows a side bottom view of the optical mounting system 400 including the second alignment screw 511, a second alignment hard-flat 604, and a second ball 605. Flexure of the example second alignment flexure 420 may be accomplished using the second alignment screw 511. For example, the second alignment screw 511 may be a ball-ended screw terminating in the second ball 605. The example second alignment hard-flat 604 may be recessed within a lower surface of the middle plate 414. The example second alignment screw 511 can be adjusted such that the second ball 605 pushes against the second alignment hard-flat 604 and causes flexure of the second alignment flexure 420. As such, the angle of the middle plate 414 relative to the lower plate 415 can be adjusted.

Pre-loading gauges 606 can be used with an appropriately sized pin such that the second alignment screw 603 is adjusted such that the pin barely fits it. In this way, the first alignment flexure 418 and the second alignment flexure 420 can be easily loaded during the assembly process, and at the same time additional mass is removed from the mount. This configuration is repeated for each alignment flexure. It should be noted that the monolithic optical mount 412 can be fabricated so the three plates (e.g., the top plate 413, the middle plate 414 and the lower plate 415) of the optical mount 412 are not initially parallel, but after pre-loading adjustments, become parallel for normal operation. The additional removal of mass has the benefits previously described.

Additional material can be removed from the mounting surface 607 to create surfaces which approximate the three points 608 of a kinematic to constrain three of the mount's 6 degrees of freedom. Additional material can be removed from two orthogonal sides 609 of the mounting surface 607 in the form of two surfaces on one side and one surface on the other to constrain the remaining degrees of freedom. The additional removal of mass has the benefits previously described.

FIG. 6B shows a side bottom view of the optical mounting system 450 having the first screw 402, the second screw 407, and the third screw 409 removed. FIG. 6B illustrates the location of the first tapped hole 411 which accommodates the first screw 402.

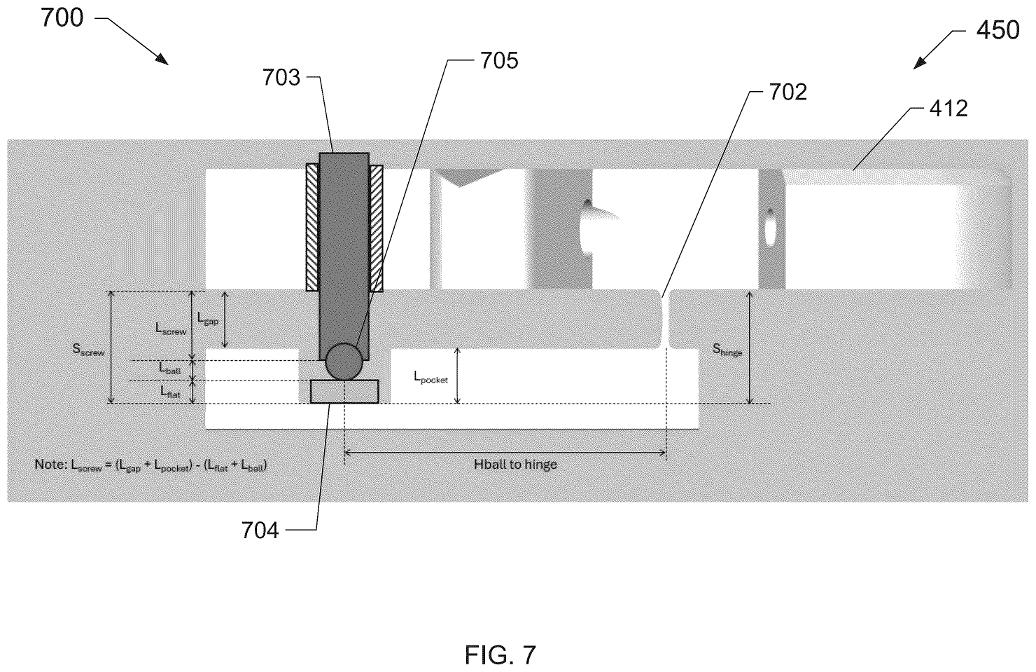

FIG. 7 shows a schematic diagram for the calculation of balancing thermal expansion of a hinge of the optical mount 412 with a screw and a flat. In FIGS. 5 and 6, the alignment flexures 418, 420, the alignment screws 505, 511, the alignment hard-flats 504, 604 and the balls 509, 605 are shown or described. These features are also schematically shown in FIG. 7 as a flexure 702 (e.g., corresponding to one of the first alignment flexure 418 or the second alignment flexure 420), a screw 703 (e.g., corresponding to one of the first alignment screw 505 or the second alignment screw 511), a flat 704 (e.g., corresponding to one of the first alignment hard-flat 507 or the second alignment hard-flat 604), and a ball 705 (e.g., corresponding to one of the first ball 509 or the second ball 605).

Since each of these elements have different coefficients of thermal expansion (CTE), any change in temperature causes S_{hinge} and S_{screw} to expand different amounts, and this in turn would cause an optical element (e.g., optical element 501) mounted in the optical mount 412 to change angle. The angle change of the optical element would then be amplified at the region of interest by the working distance of the optical mounting system 450. The movement of the optical mount can be quantified based on the geometry of the monolithic optical mount 412 and the dimensions and thermal expansion coefficients of the screws 505, 511 respectively, the alignment hard-flats 507, 604 respectively, the balls 509, 605 respectively, and the distance from the screw to the flex hinge Hball to hinge as follows.

The expansion of the “screw” column (DSscrew) is defined in Equation 1 below based on the temperature differential (DT), the length of the screw (Lscrew), the coefficient of thermal expansion of the screw (CTEscrew), the length of the ball portion of the stack-up (Lball), the coefficient of thermal expansion of the ball (CTEball), the length of the hard-flat (Lflat) and the coefficient of thermal expansion of the hard-flat (CTEflat). The expansion of the “hinge” column (DShinge) is defined in Equation 2 below based on the temperature differential (DT), the length of the gap (Lgap), the coefficient of thermal expansion of the hinge (CTEhinge), the length of the pocket (Lpocket) and the coefficient of thermal expansion of the base plate (CTEbase plate).

$$DSscrew = DT * ( Lscrew * CTEscrew + Lball * CTEball + Lflat * CTEflat ) \qquad ( Equation 1 )$$

$$DShinge = DT * ( Lgap * CTEhinge + Lpocket * CTEbase plate ) \qquad ( Equation 2 )$$

The differential expansion (DH) is defined in Equation 3 below based on DSscrew and DShinge calculated in Equations 1 and 2 respectively. The angular change (Dq) is defined in Equation 4 below based on DH calculated in Equation 3 and the distance between the ball and the hinge (Hball to hinge). The beam movement (DB) is defined in Equation 5 below in the small angle limit based on Dq calculated in Equation 4 and the working distance (WD). In examples disclosed herein, the WD is approximately 25 mm.

$$DH = DSscrew - Dshinge \qquad ( Equation 3 )$$

$$Dq = atan ( \frac{DH}{Hball} to hinge ) \qquad ( Equation 4 )$$

$$DB = Dq * WD \qquad ( Equation 5 )$$

Through an iterative process of geometrical design and material selection, the thermal response of the optical mounting system 450 can be brought to zero. Typical CTE values for an optical system are shown in Table 1 and an example calculation is shown in Table 2.

TABLE 1

| Material | CTE (1/C) |
|---|---|
| Sapphire | 6.00 × 10⁻⁶ |
| Carbide, 6% Co | 5.00 × 10⁻⁶ |
| 52100 carbon steel | 1.19 × 10⁻⁵ |
| 303 stainless steel | 1.74 × 10⁻⁵ |
| 17-4 stainless steel | 1.08 × 10⁻⁵ |
| Titanium grade 5 (Ti6Al4V) | 8.60 × 10⁻⁶ |
| Temperature Differential (C.) | 65 |
| Assumed working distance (mm) | 25.0 |

TABLE 2

| | Dimension | | Material | CTE |
|---|---|---|---|---|
| Top hinge: | L_gap (mm) | 14 | 17-4 stainless | 1.08 × |
| | | | steel | 10⁻⁵ |
| | L_pocket (mm) | 0.5 | 303 stainless | 1.74 × |
| | | | steel | 10⁻⁵ |
| | L_flat (mm) | 6.35 | Carbide, 6% | 5.00 × |
| | | | Co | 10⁻⁶ |
| | L_ball (mm) | 1.98 | Carbide, 6% | 5.00 × |
| | | | Co | 10⁻⁶ |
| | L_screw (mm) | 6.17 | 303 stainless | 1.74 × |
| | | | steel | 10⁻⁵ |
| | Horiz_ball_to_{—} | 16.3 | | |
| | hinge (mm) | | | |
| | dS_screw (μm) | 9.69 | | |
| | dS_hinge (μm) | 10.39 | | |
| | delta (μm) | −0.71 | | |
| | Angle (rad) | −4.34 × | | |
| | | 10⁻⁵ | | |
| | Beam movement | −1.09 | | |
| | (μm) | | | |

This iterative process is combined with a second iterative numerical analysis which maximizes the design to shock and vibration sensitivity by zeroing, or getting as close to zero as possible, the integral of m (x, y, z)*(g−vec dot r−vec), for each alignment flexure. For this analysis the mass of the optical element 501 must be known. When adjusting the design to zero the torque, it is advantageous to remove material (e.g., via the lightening holes 416), to get the secondary benefits of lower mass, lower thermal mass, and increased surface area.

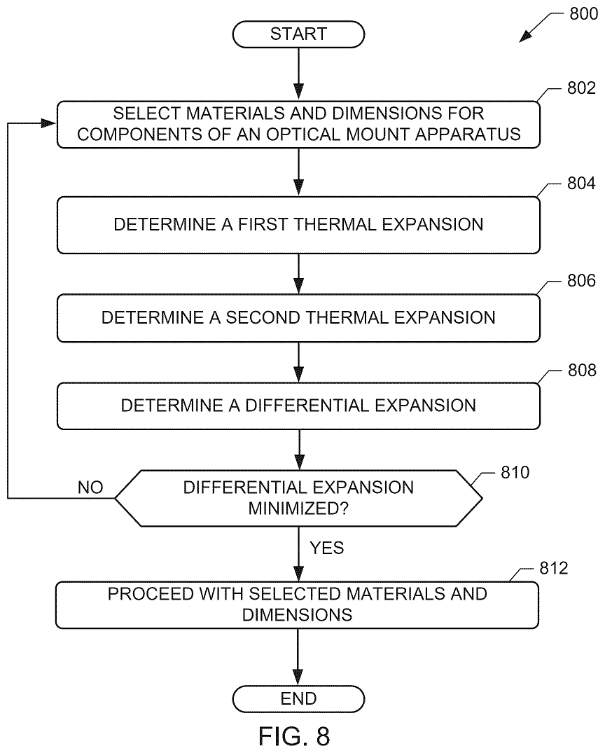

FIG. 8 is a flow diagram illustrating an example procedure 800 for minimizing thermal expansion effects for an optical mount (e.g., the optical mounting system 400). Although the procedure 800 is described with reference to the flow diagram illustrated in FIG. 8, it should be appreciated that many other methods of performing the functions associated with the procedure 800 may be used. For example, the order of the blocks may be changed, certain blocks may be combined with other blocks, and many of the blocks described are optional.

The example procedure 800 beings at block 802 when materials and dimensions for components of an optical mount apparatus are selected. For example, a material of a body of an optical mount (e.g., optical mount 412), a material of a screw (e.g., one of the alignment screws 505, 511), a material of a ball-end of an alignment screw (e.g., one of the first ball 509 or the second ball 605), and a material of a hard-flat (e.g., one of the first alignment hard-flat 507 or the second alignment hard-flat 604) are selected. Additionally, dimensions such as the length of the screw, the length of the hard flat, the length of the ball, the length of the gap between plates of the optical mount and the length of a pocket housing the hard-flat are selected.

At block 804, a first thermal expansion is determined based on the materials and dimensions selected at block 802. For example, the first thermal expansion may correspond to the expansion of the “screw” column (DSscrew) as shown in FIG. 7 and may be calculated based on Equation 1 above. At block 806, a second thermal expansion is determined based on the materials and dimensions selected at block 802. For example, the second thermal expansion may correspond to expansion of the “hinge” column (DShinge) as shown in FIG. 7 and may be calculated based on Equation 2 above. At block 808, a differential expansion is determined based on the first thermal expansion and the second thermal expansion. For example, using Equation 3 above, a difference between the first thermal expansion and the second thermal expansion may be calculated to determine the differential expansion.

At block 810, the procedure 800 checks if the differential expansion calculated at block 808 has been minimized. For example, if the differential expansion is calculated to be zero or below a threshold value, the example procedure 800 continues to block 812. At block 812, the procedure continues with a design of the optical mount based on the materials and dimensions selected at block 802 and the procedure 800 ends. If the differential expansion is calculated to be non-zero or above a threshold value, the example procedure 800 returns to block 802 to select new materials and/or dimensions for one or more components of the optical mount apparatus.

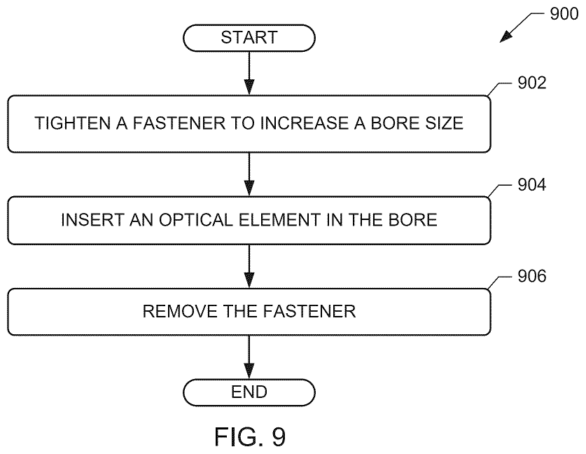

FIG. 9 is a flow diagram illustrating an example procedure 900 for mounting an optical element (e.g., the optical element 501) in an optical mount (e.g., the optical mount 412), according to an example embodiment of the present disclosure. Although the procedure 900 is described with reference to the flow diagram illustrated in FIG. 9, it should be appreciated that many other methods of performing the functions associated with the procedure 900 may be used. For example, the order of the blocks may be changed, certain blocks may be combined with other blocks, and many of the blocks described are optional.

The example procedure 900 begins at block 902 when a fastener is tightened to increase a bore size of an optical mount. For example, the first screw 402 may be tightened against the first flexure arm 403. As a result, the second flexure arm 404 may pivot around the flexure element 405 and increase the size of the cutout 401. In some examples, tightening of the first fastener may be limited by interference of a second fastener installed in a second opening of the optical mount.

At block 904, an optical element (e.g., the optical element 501) is inserted into the bore (e.g., the cutout 401 of the optical mount 412). For example, a portion of the optical element having a diameter smaller than the bore may be inserted axially into the cutout 401. In some examples, a third fastener (e.g., the third screw 409) may limit translation of the optical element through the bore. In some examples, the third fastener may be translated in order to cause the optical element to translate through the bore, thus adjusting the position of the optical element.

At block 906, the first fastener of block 902 is removed from the optical mount. As a result of removal of the first fastener, the bore size may reduce such that the optical element is held firmly within the optical mount.

### CONCLUSION

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

It should be appreciated that 35 U.S.C. 112 (f) or pre-AIA 35 U.S.C 112, paragraph 6 is not intended to be invoked unless the terms “means” or “step” are explicitly recited in the claims. Accordingly, the claims are not meant to be limited to the corresponding structure, material, or actions described in the specification or equivalents thereof.

The invention is claimed as follows:

1. An optical mount apparatus, the optical mount apparatus comprising:
a body comprising:
a bore for an optical element;
a first opening for a first fastener; and
a first flexure arm, wherein tightening of the first fastener against the first flexure arm causes a second flexure arm to pivot around a flexure element and increase a size of the bore.

2. The optical mount apparatus of claim 1, wherein the body of the optical mount apparatus further includes a second opening for a second fastener, wherein when the second fastener is installed in the second opening, the second fastener limits tightening of the first fastener.

3. The optical mount apparatus of claim 2, wherein the installed second fastener prevents the second flexure arm from exceeding its elastic deformation limit.

4. The optical mount apparatus of claim 1, wherein the body of the optical mount apparatus further includes a third opening for a third fastener, wherein when the third fastener is installed in the third opening, the third fastener limits translation of the optical element through the bore.

5. The optical mount apparatus of claim 4, wherein translation of the third fastener in the third opening causes the optical element to translate through the bore.

6. The optical mount apparatus of claim 1, wherein the size of the bore is smaller than the size of a portion of the optical element mounted in the bore.

7. The optical mount apparatus of claim 1, wherein the body of the optical mount apparatus is fabricated from a single monolithic block of material.

8. An optical mount apparatus, the optical mount apparatus comprising:
a body comprising:
a bore for an optical element on a top plate;
a first alignment flexure between a top plate of the body and a middle plate of the body, the top plate including the bore; and
a second alignment flexure between the middle plate and a lower plate of the body, wherein the first alignment flexure and the second alignment flexure flexing adjusts an the angle of the top plate; and
a first ball-ended alignment screw; and
a first hard flat on a bottom portion of the top plate; wherein tightening the first ball-ended alignment screw against the first hard flat causes flexion in the first alignment flexure.

9. The optical mount apparatus of claim 8, wherein one of a material of the first ball-ended alignment screw and a material of the first hard flat has a thermal expansion coefficient greater than a thermal expansion coefficient of a material of the body of the optical mount apparatus and the other one of the material of the first ball-ended alignment screw and the material of the first hard flat has a thermal expansion coefficient less than the thermal expansion coefficient of the material of the body of the optical mount apparatus.

10. The optical mount apparatus of claim 9, wherein dimensions and a material of the first ball-ended alignment screw, dimensions of a ball of the first ball-ended alignment screw, dimensions and a material of the first hard flat, dimensions of a gap between the top plate and the middle plate, and a material of the body are selected to minimize a change in angle of the first alignment flexure due to temperature change.

11. The optical mount apparatus of claim 8, further including:
a second-ball-ended alignment screw; and
a second hard flat on a bottom portion of the middle plate, wherein tightening of the second ball-ended alignment screw causes flexion in the second alignment flexure.

12. The optical mount apparatus of claim 11, wherein one of a material of the second ball-ended alignment screw and a material of the second hard flat has a thermal expansion coefficient greater than a thermal expansion coefficient of a material of the body of the optical mount apparatus and the other one of the material of the second ball-ended alignment screw and the material of the second hard flat has a thermal expansion coefficient less than the thermal expansion coefficient of the material of the body of the optical mount apparatus.

13. The optical mount apparatus of claim 12, wherein dimensions and a material of the second ball-ended alignment screw, dimensions of a ball of the second ball-ended alignment screw, dimensions and a material of the second hard flat, dimensions of a gap between the middle plate and the bottom plate, and a material of the body are selected to minimize a change in angle of the first second flexure due to temperature change.

14. The optical mount apparatus of claim 8, further including:
an optical element of known mass secured into the bore; and
a mass of the body is designed to minimize one or more of:
a difference between a first sum of mass times distance on a first side of the first alignment flexure and a second sum of mass time distance on a second side of the alignment flexure, and
a difference between a third sum of mass times distance on a first side of the second alignment flexure and a fourth sum of mass times distance on a fourth side of the second alignment flexure.

15. The optical mount apparatus of claim 14, wherein one or more lightening holes are added to the top plate to minimize the difference between the first sum of mass and the second sum of mass.

16. The optical mount apparatus of claim 14, wherein one or more lightening holes are added to the middle plate to minimize the difference between the third sum of mass and the fourth sum of mass.

17. A method of designing an optical mount apparatus, the method including:
determining a first thermal expansion of a screw portion of the optical mount apparatus;
determining a second thermal expansion of a hinge portion of the optical mount apparatus;
determining a differential expansion based on a difference between the first thermal expansion and the second thermal expansion; and
selecting materials for one or more components of the optical mount apparatus and selecting dimensions of one or more components of the optical mount apparatus to minimize the differential expansion.

18. The method of claim 17, wherein the first thermal expansion is based one or more of a length of a screw, a length of a ball, a length of a hard-flat, a coefficient of thermal expansion of the screw, a coefficient of thermal expansion of the ball, and a coefficient of thermal expansion of the hard-flat.

19. The method of claim 17, wherein the second thermal expansion is based on one or more of a length of a gap, a length of a pocket, a coefficient of thermal expansion of a hinge, and a coefficient of thermal expansion of a base plate.

20. A method for mounting an optical element in an optical mount, the method including:
tightening a first fastener in a body of the optical mount to increase a size of a bore in the body of the optical mount;
inserting the optical element in the bore; and
removing the first fastener from the body of the optical mount.

21. The method of claim 20, further including tightening the first fastener in the body of the optical mount until translation of the first fastener is limited by a second fastener in the body of the optical mount.

22. The method of claim 21, further including removing the second fastener from the body of the optical mount after the removing of the first fastener.

23. The method of claim 20, further including inserting the optical element into the bore until the optical element is limited in translation by a third fastener in the body of the optical mount.

24. The method of claim 23, further including translating the optical element by translating the third fastener through the body of the optical mount.

25. The method of claim 20, further including tightening one or more alignment screws to adjust an angle of a top plate of the body of the optical mount.
